(19) United States
(12) Patent Application Publication
(10) Pub. No.: US 2011/0209944 A1
(43) Pub. Date: Sep. 1, 2011

(54) DEER STAND SECURABLE FROM GROUND

(76) Inventors: Martin A. Humphrey, Byron, GA (US); Wendell A. Parker, Centerville, GA (US)

(21) Appl. No.: 13/037,795

(22) Filed: Mar. 1, 2011

Related U.S. Application Data
(60) Provisional application No. 61/309,155, filed on Mar. 1, 2010.

(51) Int. Cl. A01M 31/02

(52) U.S. Cl. 182/116

(57) ABSTRACT

The present invention is a light weight, packable ladder stand generally used for hunting. It is made of aluminum parts and can be folded, demounted or slid into a back pack configuration that weighs about thirty pounds with an aluminum ladder. The weight may be further reduced in alternate ladder configurations, such as reinforced plastic ladder. The ladder stand can be anchored to the tree by a single person from the ground location without having to climb the ladder. This allows the deer stand to be easily transported and installed by a lone hunter without climbing the ladder prior to securing the ladder to the tree.

### REFERENCE TO RELATED APPLICATIONS

This application claims priority to commonly owned U.S. Provisional Patent Application Ser. No. 61/309,155 titled “Fold Up Packable Deer Stand” filed Mar. 1, 2010, which is incorporated by reference.

### FIELD OF THE INVENTION

This invention pertains to deer stands and, more particularly, to a ladder-type deer stand securable to a tree from the ground and packable into a convenient backpack configuration allowing the deer stand to be transported and installed by one person.

### BACKGROUND

There are three types of stands currently on the market:

Traditional Ladder Stands

This stand can be one piece, or breakdown into three or more pieces. It is twelve to sixteen feet high and sections are four feet or longer. It is made of steel and ranges in weight from fifty to one hundred pounds. The ladder is first leaned against a tree while a second person holds the stand, then the first person climbs the ladder and secures the ladder to the tree. This stand requires that you make a first trip to scout for a place to set up, then go back on a second trip to set the stand up, and third go back again to hunt. This stand is considered semi-permanent because of the time and effort it takes to set it up.

Climbing Stands

This stand consists of two sections that are secured around the tree independently. It weighs thirty five to sixty pounds. The hunter sits on the bottom section and uses the top section to pull up thus climbing the tree with the stand. The top section is used for sitting while the lower section is used to prop the hunter's feet. The hunter can carry it in, find a place to hunt and follow the above procedure and hunt. But this stand requires that you go through the climbing procedure twice, (up and down) every time a person hunts. It can be noisy, strenuous and very dangerous if not used properly.

Hanging Stands

This stand is similar to the climbing stand accept the hunter has to use a portable ladder to get up and down the tree. A narrow ladder is used that is in five feet sections and straps to the tree. After the ladder is attached to the tree the hunter climbs the ladder and attaches the stand in the tree above the ladder. Another option includes steps that are screwed into the tree. Because of the time and trouble these set ups are considered semi-permanent. An advantage with this stand is once the stand is set up the hunter can go up and down the ladder quietly. This stands disadvantage is the hunter must carry the ladder and the stand (each can weigh thirty pounds or more), and a gun or bow. Also moving the stand even a short distance is a lot of trouble, strenuous and dangerous if not used properly.

However, none of the deer stands currently available include a ladder that is configured to be carried by and installed by a single person without having to climb the ladder or the tree prior to securing the ladder to the tree. There is, therefore, a need for a packable deer stand that can be conveniently carried and safely installed by a single person without having to climb the ladder or the tree prior to securing the ladder to the tree.

### SUMMARY OF THE INVENTION

The present invention meets the needs described above in a deer stand that is configured to lean against and be secured to a tree by a single person operating from the ground without having to climb the ladder or the tree prior to securing the ladder to the tree. The deer stand includes a ladder having a tree anchor connected at or near an upper end of the ladder configured to engage a tree while the ladder extend upwards from the ground and leans against the tree. The ladder is typically packable in that the ladder includes several sections that can be folded, demounted or slid with respect to each other from an extended position to a retracted or packed position to facilitate human carrying of the deer stand, preferably in a backpack configuration that is easily carried by a single individual.

A cable anchor is located at or near a lower end of the ladder. The cable may be a typical stranded wire cord, nylon strap, leather strap, textile rope, elastic cord, bungee cord, or any other suitable type of tether. When the ladder is extended and leaned against a tree, at least one cable extends from the tree anchor to or near the ground level, where a person standing on the ground can easily wrap the cable around the tree and couple the cable to the cable anchor. Preferably, two cables extend from tree anchor for coupling with the cable anchor. The cables may be permanently attached to the tree anchor or removably attachable to tree anchor prior to standing the ladder upright and leaning the ladder against the tree. A cable tensioning device is used to tighten the cables while the cables extend from the tree anchor, around the tree, and are coupled to the cable anchor to secure the deer stand to the tree. As a result, the cables are configured to be wrapped around the tree, coupled to the cable anchor, and tightened to secure the ladder to the tree by an operator standing on the ground without climbing the ladder prior to tightening the cable to secure the ladder to the tree.

The tree anchor typically includes teeth for digging into the tree when the ladder is tightened to the tree to aid is securing the ladder to the tree. The cable tensioning device may be a winch for gathering and tightening the cable. The deer stand may also include a seat and a foot rest located at or near the upper end of the ladder. The deer stand may also include one or more tree braces configured to extend from an intermediate location on the ladder to the tree when the deer stand is secured to the tree. Typically, one tree brace is located at each junction between ladder sections.

In a first alternative, the ladder includes a number of sections connected to each other by hinges with the sections configured to be folded against each other into a packed configuration to facilitate human carrying of the deer stand. In a second alternative, the ladder sections are removably connected to each other by separable couplers, in which case the sections can be separated from each other facilitate human carrying of the deer stand. In a third alternative, the ladder sections are slidably connected to each like a conventional extension ladder, in which case the sections are configured slide with respect to each other into a retracted configuration to facilitate human carrying of the deer stand.

It will be appreciated that the preceding summary, the appended drawings, and the following detailed description relate to the preferred embodiments of the invention. Many changes may be made to the specific embodiments within the scope and spirit of the invention, which is defined by the claims following the detailed description of the embodiments.

### BRIEF DESCRIPTION OF THE DRAWINGS

FIG. 1 is a front view of the deer stand standing on end in a folded configuration.

FIG. 2 is a perspective view of the deer stand standing on end in a folded configuration.

FIG. 3 is a perspective view of the deer stand stand laying on the ground in a folded configuration.

FIG. 4 is a perspective view of the deer stand laying on the ground with a first section unfolded.

FIG. 5 is a perspective view of the deer stand laying on the ground with first and second sections unfolded.

FIG. 6 is a perspective view of the deer stand laying on the ground fully extended with first, second and third sections unfolded.

FIG. 7 is a perspective view from the side of the deer stand laying on the ground showing the extension of the lower tree brace.

FIG. 8 is a perspective view from the side of the deer stand laying on the ground showing the extension of the upper tree brace.

FIG. 9 is a perspective view from the side of the deer stand laying on the ground showing the tree anchor, seat and foot rest at the top of the deer stand.

FIG. 10 is a perspective view from the side of the deer stand installed against a tree showing the tree anchor, seat and foot rest at the top of the deer stand.

FIG. 11 is a perspective view from the side of the deer stand installed against a tree showing the upper and lower tree braces.

FIG. 12 is a front view of the deer stand installed against a tree showing cable attachment.

FIG. 13 is a perspective view from the rear of the deer stand installed against a tree showing cable attachment.

FIG. 14 is a perspective view from the side of the deer stand installed against a tree showing the full length of the deer stand.

FIG. 15 is a perspective view from the side of the deer stand installed against a tree showing the upper and lower tree braces.

FIG. 16 is a perspective view of a hinge of the deer stand.

FIG. 17 is a perspective view of two hinges, the cable support, and a portion of the lower tree brace of the deer stand.

FIG. 18 is a perspective view of the seat and tree anchor of the deer stand.

FIG. 19 is a perspective view of the seat and tree anchor of the deer stand illustrating cable routing through the seat support.

FIG. 20A shows a demountable alternative ladder for the deer stand including separable ladder sections connected by demountable couplers, such as the male-female couplers shown with the sections separated.

FIG. 20B shows the demountable alternative ladder of FIG. 20A with the sections connected.

FIG. 21A shows a sliding ladder alternative for the deer stand ladder in a retracted configuration including ladder sections that slide with respect to each other similar to a conventional extension.

FIG. 21B shows the sliding ladder alternative of FIG. 21A in an extended configuration.

### DETAILED DESCRIPTION OF THE EMBODIMENTS

The present invention does all that the previous stands do with several advantages. It can be configured to weigh about thirty pounds with an aluminum ladder. The weight may be further reduced in alternate configurations, for example with a reinforced plastic ladder. The packable deer stand folds down into a back pack mode so the hunter can carry it in, find a place to hunt, put up the stand and hunt without the help of another person or the burden of carrying a heavy stand. With this stand, from the ground, which has a no climb anchor system, the hunter can attach the stand to the tree safely and hunt. It takes three to four minutes to put up the stand. The way the stand works is, the ultra light weight but still super strong ladder-stand is achieved through an engineered truss system that locks together as you fold out the sections of the ladder. And an anchor system that consists of steel cable that swings around the tree and out to anchor points on the ladder then down the ladder which makes a tensioning device that locks the stand to the tree.

There are at least three components of the stand that are innovative. First are the specially designed hinges that graduate in height so as to allow the ladder to be folded up in a rolling up type of motion. With all the hinges turned in the same direction this allows all the tension on the ladder to be toward the tree. The more tension, the tighter the ladder sections are pulled together. If a hinge was turned the other way, it would automatically open or collapse. Second is the bracing system that locks together up the inside of the ladder making a series of a-frame trusses with two braces going to the tree.

Third and perhaps most important is the cable system that, starting at the top, fastens to the front of the stand on each side of the seat. The cable may be permanently or removably attached to or near the tree anchor. In addition, the cable may be routed through the tube forming or supporting the tree anchor or it may be attached to the exterior of deer stand at or near the tree anchor. The cable then goes thru an eyelet on each side of the seat at the back before crossing behind the tree and coming forward to two anchor points on the front of the stand which line up with the top brace. The cables then run down the tree and space between the tree and the ladder to a ratchet that, when tightened, locks the teeth behind the seat into the tree first and then locks in the upper brace to the tree. The ratchet is coupled to a cable anchor near the bottom of the ladder and may be coupled to the cables by way of a yoke that slides back and forth through the ratchet strap so as to equalize the tension on the cables in case one of the cables ends up shorter than the other due to an irregularity in the tree. A heavy duty rope or strap may serve as a suitable yoke. A light duty strap may also be used to keep the bottom brace in a correct position against the tree.

In summary, this exceptionally light stand can be carried in as a backpack while you scout for a place to hunt. Then a lone hunter can fasten it to the tree quietly, quickly and safely. If you leave the stand, the next time you hunt you can go up the tree silently. If you need to move, you can do so quickly and quietly without any help

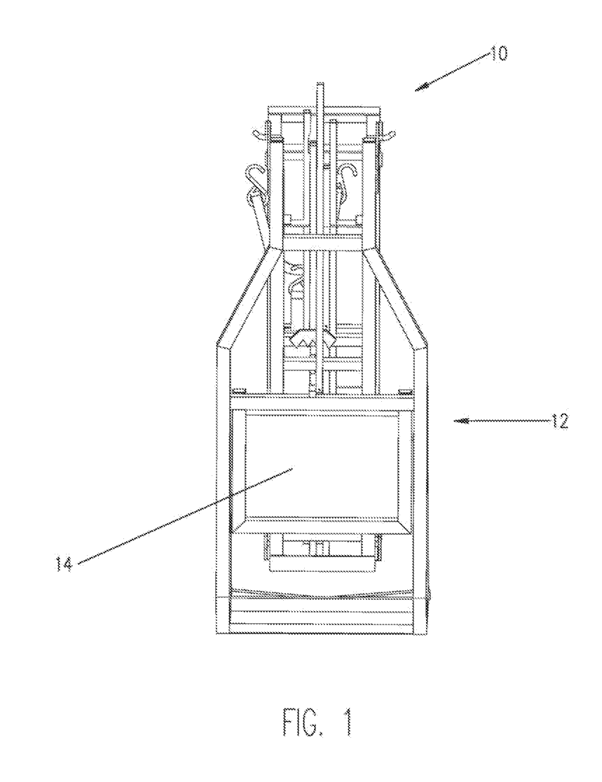

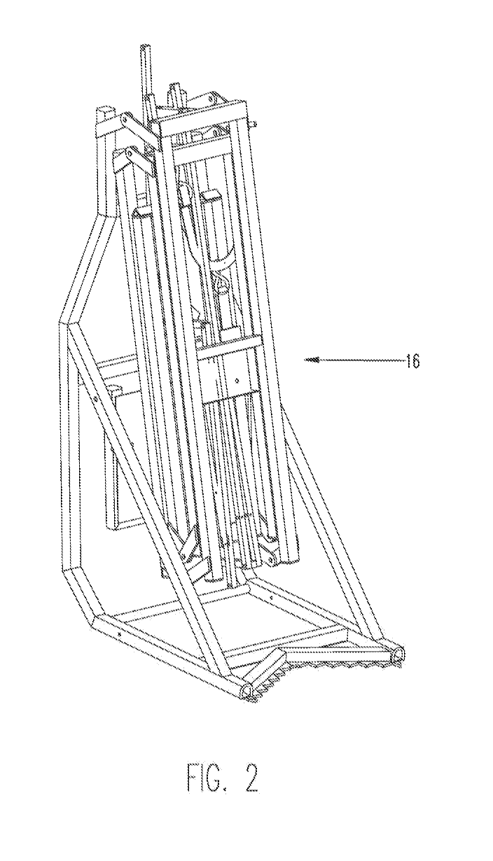

Turning now to the figures, in which like numerals refer to similar elements throughout the figures, FIG. 1 shows the packable deer stand 10 folded in a back pack mode. The stand is preferably constructed from a sturdy yet light weight material, such as aluminum, high-strength steel or reinforced plastic. Shoulder straps are attached to the forward facing portion of the frame 12, which supports the seat 15 and the foot rest 14, to allow the user to easily carry the stand like a back pack. The straps can be removable or permanently attached to the frame. FIG. 2 shows the deer stand folded in the back pack mode from a different angle providing a better view of the ladder 16. FIG. 2 shows the first step for installing the deer stand, which is to place the stand on the ground about ten feet from the tree that will be used to support the stand.

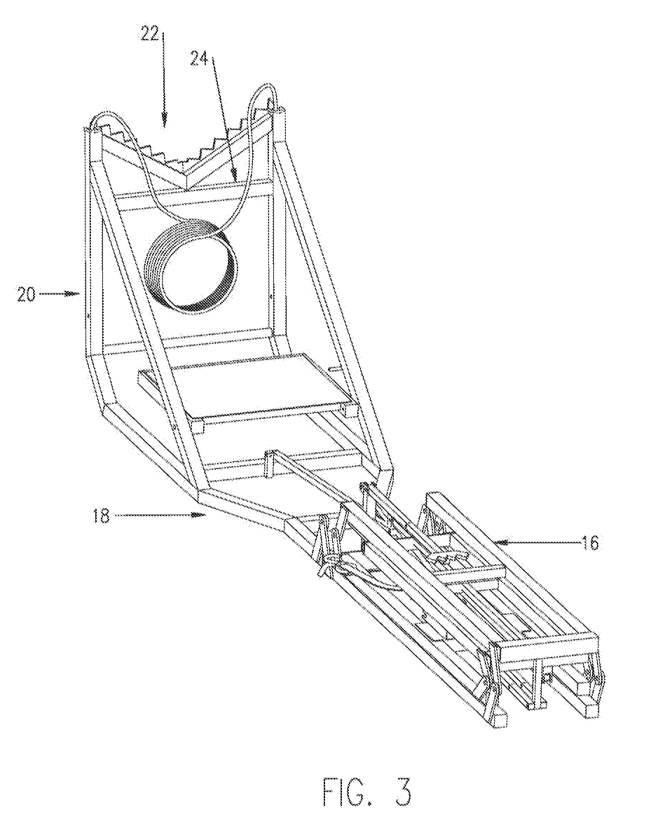

FIG. 3 shows the next step for installing the deer stand, in which the stand is tipped over and the ladder is rolled out a first time to unfold a first hinge 18 between the ladder 16 and the carriage 20 to place the ladder in a folded configuration on the ground. The carriage carries a tree anchor 22 with teeth for digging into the support tree to hold the stand securely to the tree. The carriage also carries a pair of cables 24 attached to the carriage that will be wrapped around the support tree, extend out to anchor points on the ladder, and then extend down toward the ground, and engaged with a ratchet. The ratchet will be then used to tighten the cables, which digs the teeth on the tree anchor 22 into the support tree to further secure the tree stand to the support tree

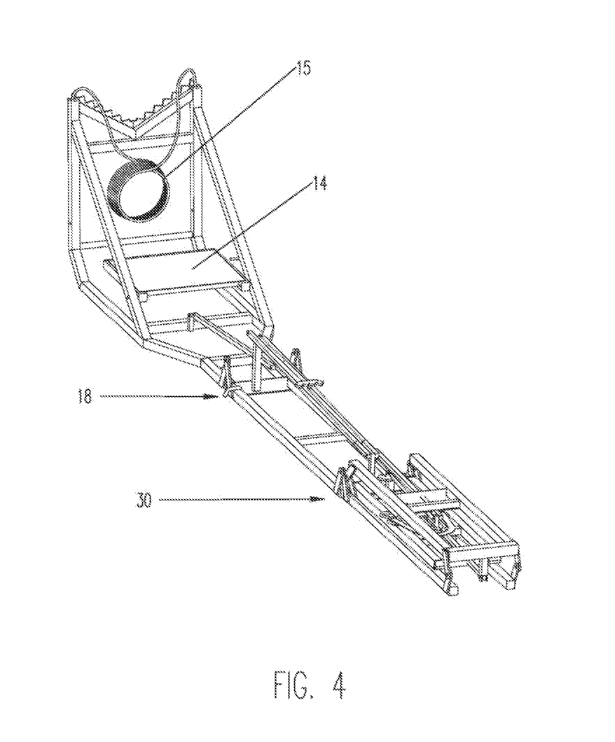

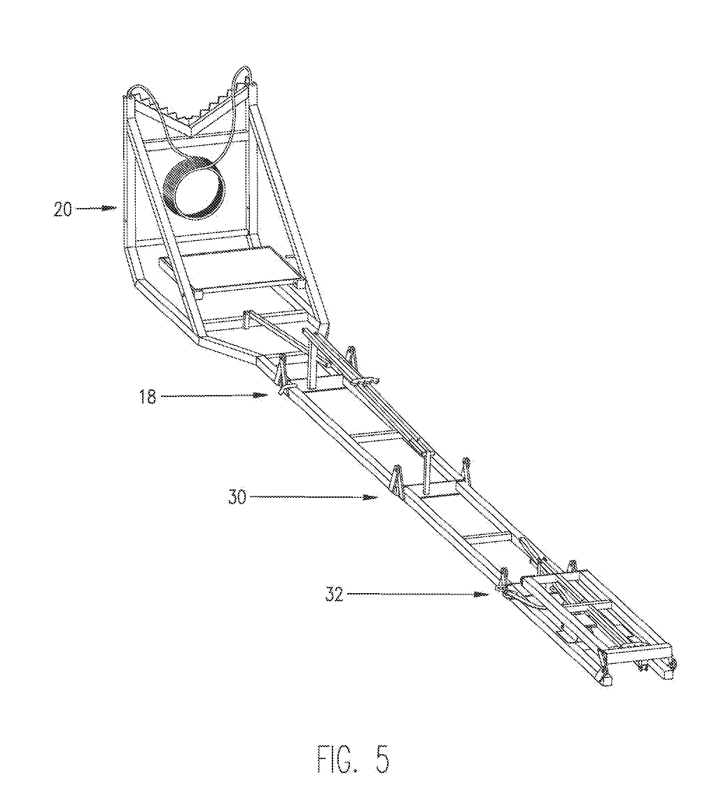

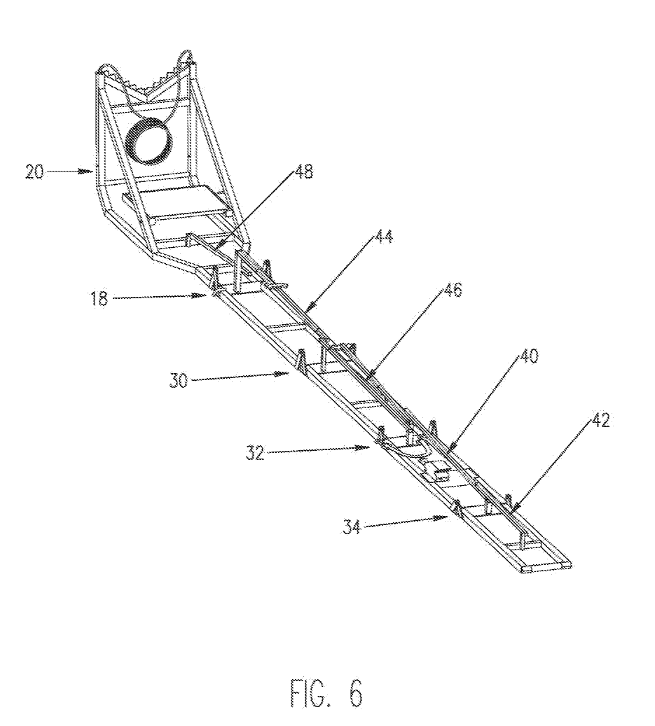

FIG. 4 shows the next step, in which ladder is rolled out a second time to unfold the second hinge 30. FIG. 5 shows the next step, in which ladder is rolled out a third time to unfold the third hinge 32. FIG. 6 shows the next step, in which ladder is rolled out a fourth time to unfold the fourth hinge 34, which places the ladder on the ground in a fully extended configuration. The hinges 34, 32 30, and 18 are progressively smaller allowing the ladder to be rolled over on itself to fold the ladder as opposed to folding the ladder in a zig-zag configuration. This allows the hinges to lock the ladder in an upright position leaning against the support tree without the any of the hinges collapsing the ladder toward the tree. In other words, when the ladder is leaned against the support tree each hinge can fold only away from the tree, not toward the tree, to prevent the ladder from collapsing toward the tree under the weight of a person climbing the ladder. FIG. 6 also shows a tree brace and strut assembly 40-48 used to hold the tree brace in place.

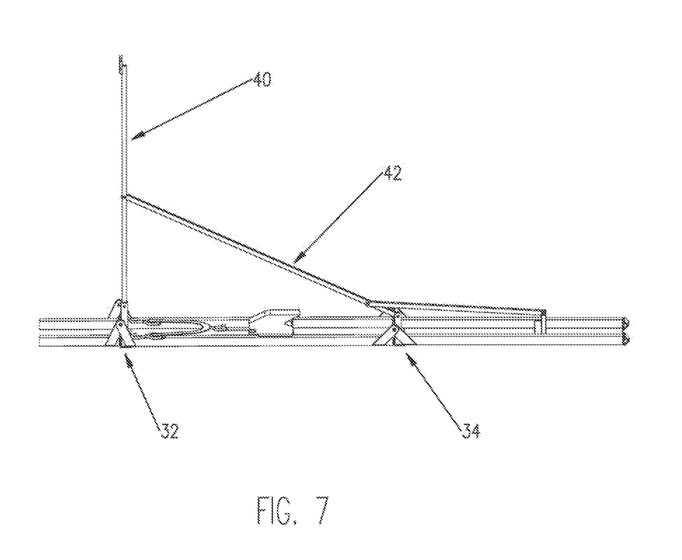

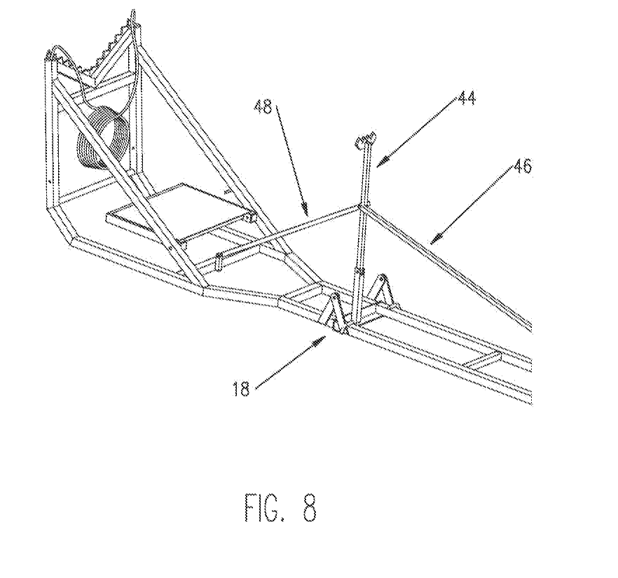

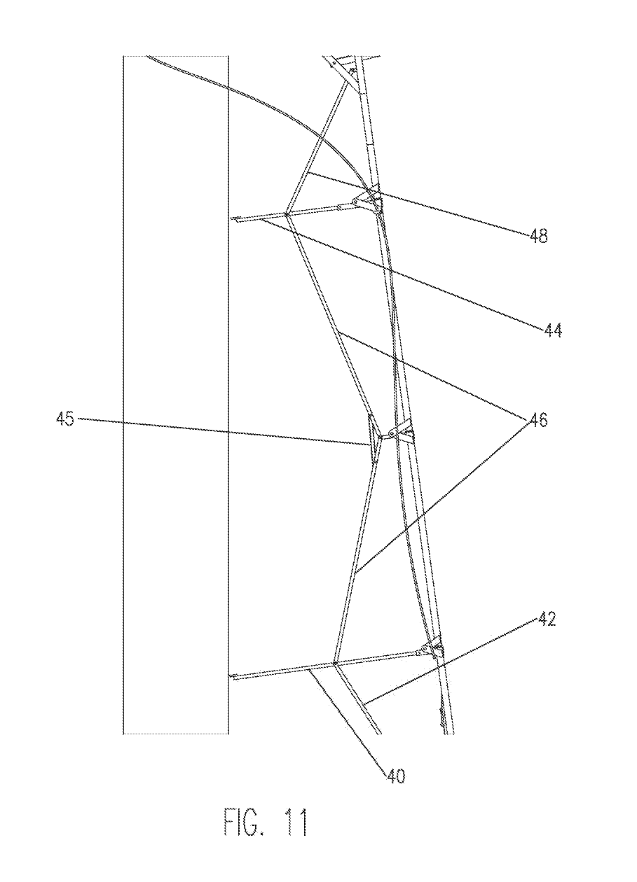

FIG. 7 shows a first tree brace 40 pivotally attached to a ladder rung near the third hinge 32 location is lifted to a position approximately perpendicular to the ladder and pinned in place by a first strut 42. The first strut 42 which is a two-piece structure attached to the lower portion of the ladder. The first strut 42 includes a hinge between its two sections and a cross brace 45 allowing the strut to fold with the ladder and unfold for attachment to the first and second tree braces 40, 44 (see FIG. 11). As shown in FIG. 8, a second tree brace 44 pivotally attached to a ladder rung near the first hinge 18 location is also lifted to a position approximately perpendicular to the ladder and pinned in place by second and third struts 46, 48 securing the second tree brace 44 to the upper portion of the ladder.

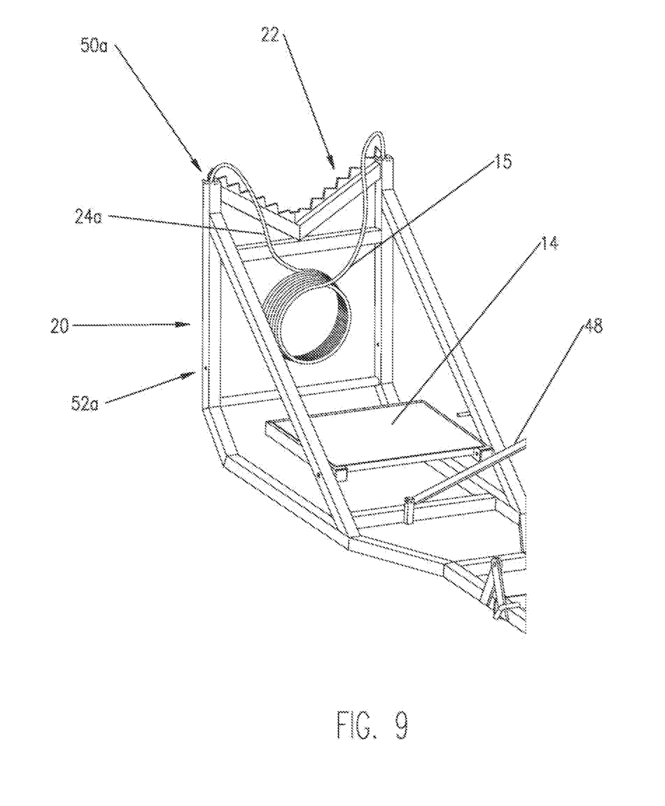

FIG. 9 shows carriage 20 including the seat 15 and the foot rest 14, the tree anchor 22 and the pair of cables. Referring to a representative cable 24a, the cables is routed through a collar 50 a on the end of the tree anchor 22 and secured to a cable anchor 52a. The cable anchor 52a is located across the upper portion of the carriage from the tree anchor 22 to help secure the carriage to the support tree and prevent the carriage from twisting or turning once the stand has been secured to the support tree. The rolled up lengths of the cables are then released and the cables are extended along the length of the ladder.

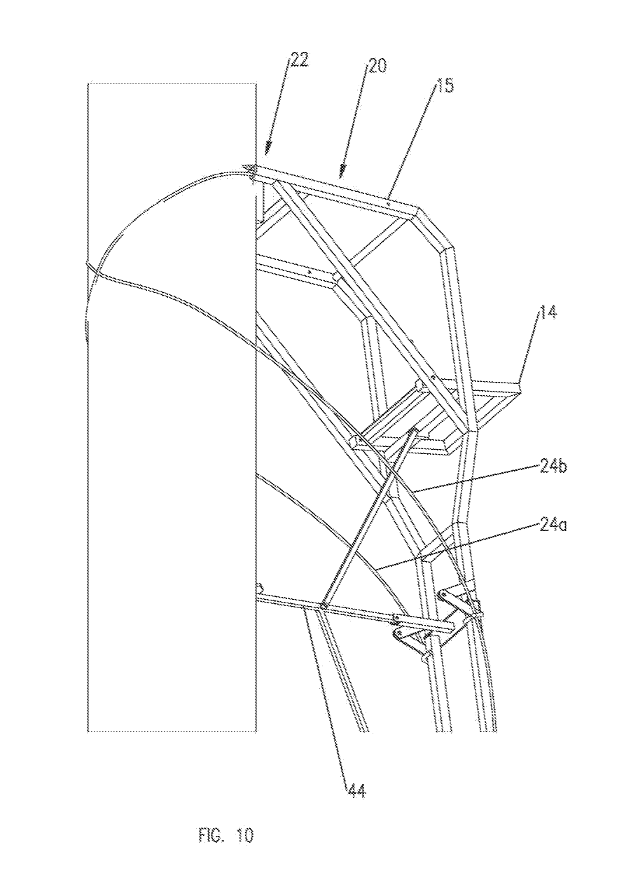

As shown in FIGS. 10 and 11, the deer stand is then lifted upright and leaned against the support tree with the teeth of the tree anchor 22 engaged with the support tree. The cables 24a-b are crossed around the support tree near the top of the stand, which is readily accomplished from the ground without having to climb the ladder before the stand has been secured to the support tree. The stand is leaned against the support tree such that the braces 40, 44 are also engaged with the support tree. The lengths of the top of the carriage 20 and the tree braces 40, 44 are selected to give the ladder 16 a desired angle, preferably about 15 degrees, with respect to the support tree when the carriage 20 and the tree braces 40, 44 are engaged with the support tree.

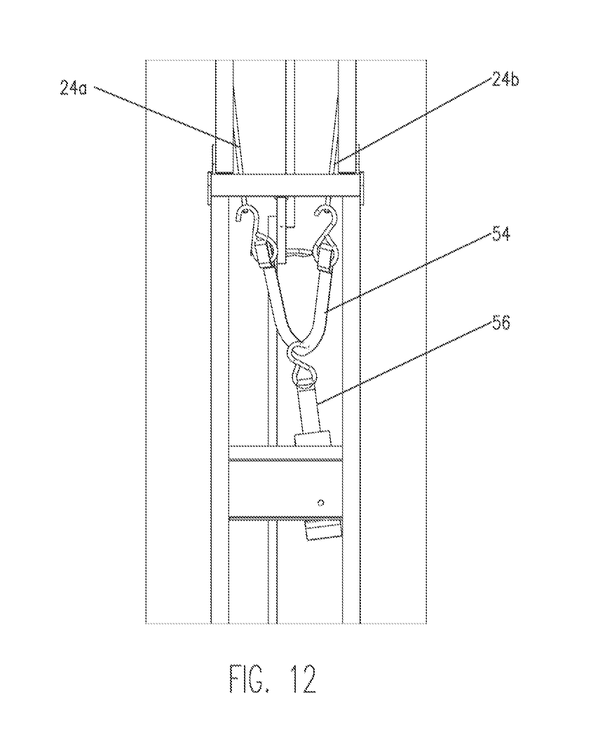

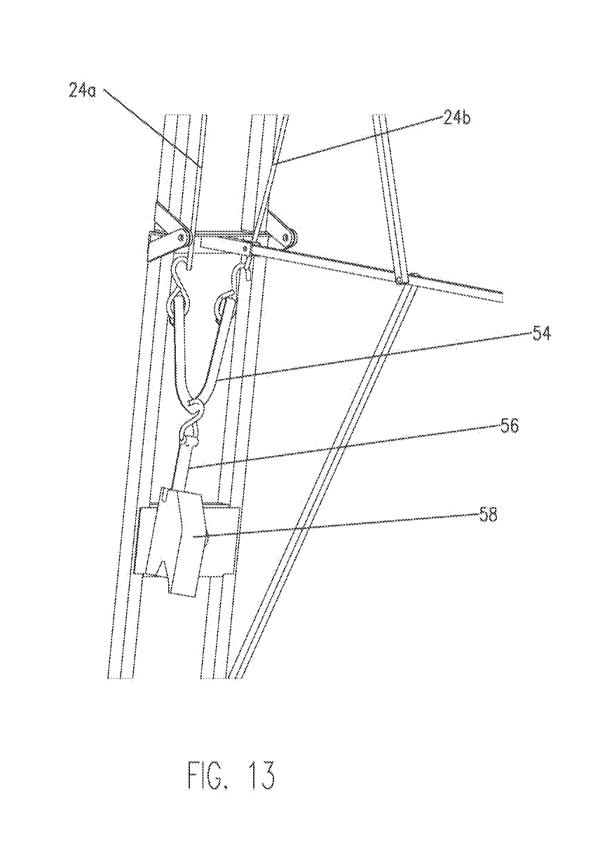

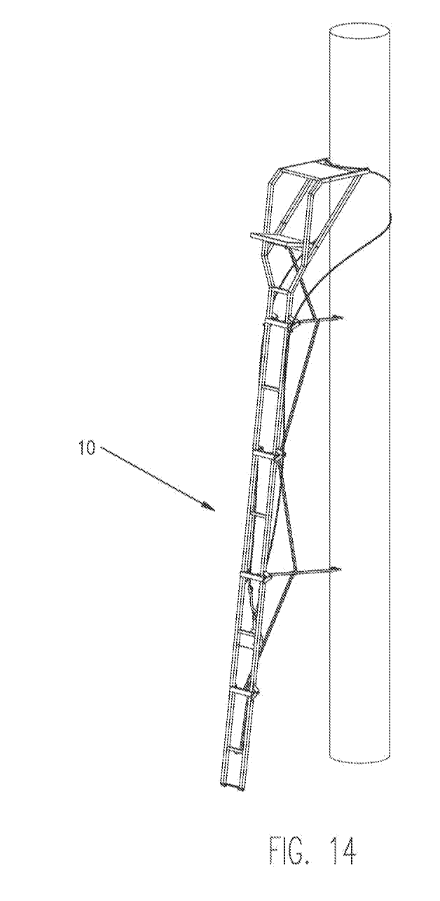

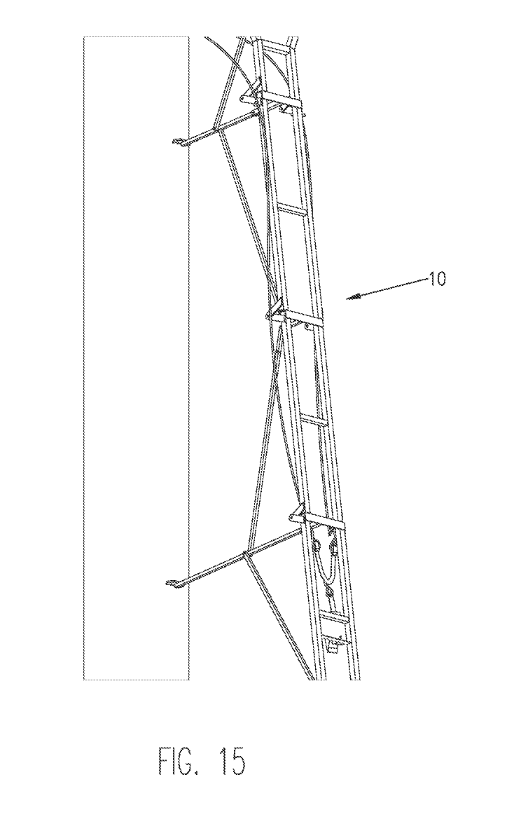

As shown in FIGS. 12 and 13, after crossing around the support tree and extending out to anchor points, the cables 24a-b extend down near the bottom of the stand where they are attached to an equalizing strap 54, which engages a loop in a winch strap 56. The equalizing strap 54 anchors the cables through the loop in the winch strap to provide a length-equalizing cable extension to adjust for differences in the heights of the cables near the bottom of the ladder due to unequal tree size or cable routing. The winch strap 56, which is connected to the reel of the ratchet 58, can then be tightened by operation of the ratchet to draw the cables downward to secure the stand to the support tree. FIGS. 14 and 15 show the deer stand 10 as properly installed against the support tree.

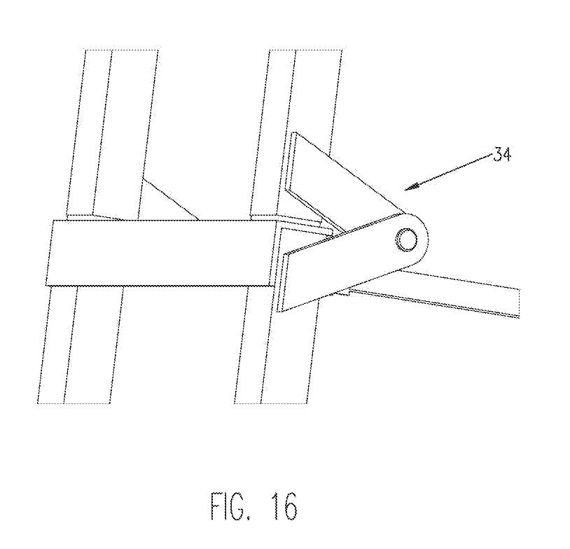

FIG. 16 shows an illustrative hinge 34. The hinge has sufficient length transverse to the ladder to allow the ladder to be rolled up on itself rather then folded in a zig-zag configuration. The configuration of the hinge also allows the hinge to fold when the stand is removed from the support tree, while also preventing the ladder from collapsing toward the support tree when the stand is leaning against the support tree.

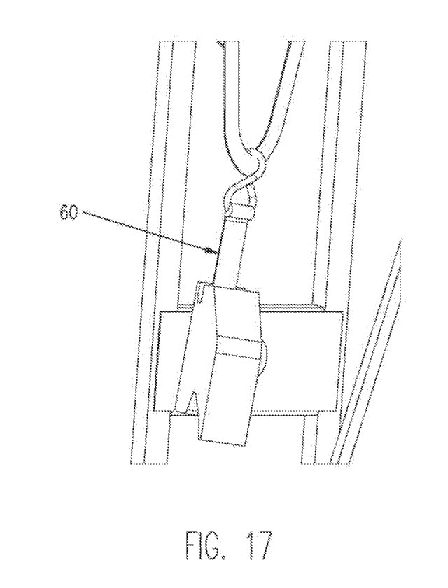

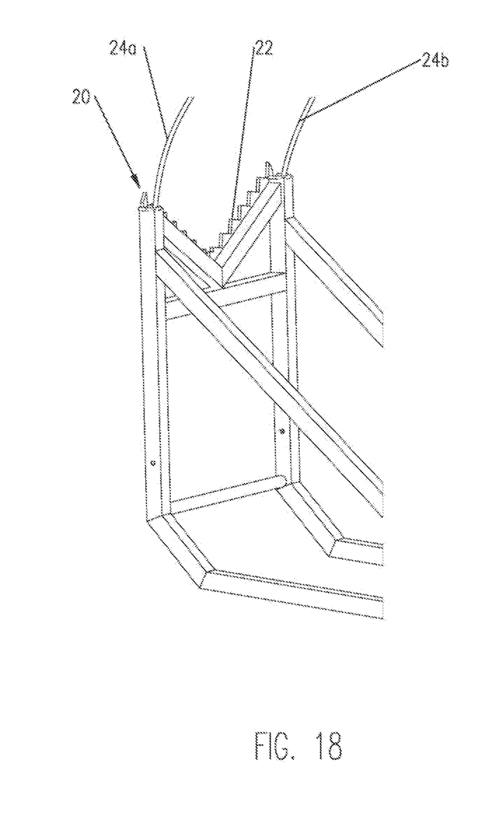

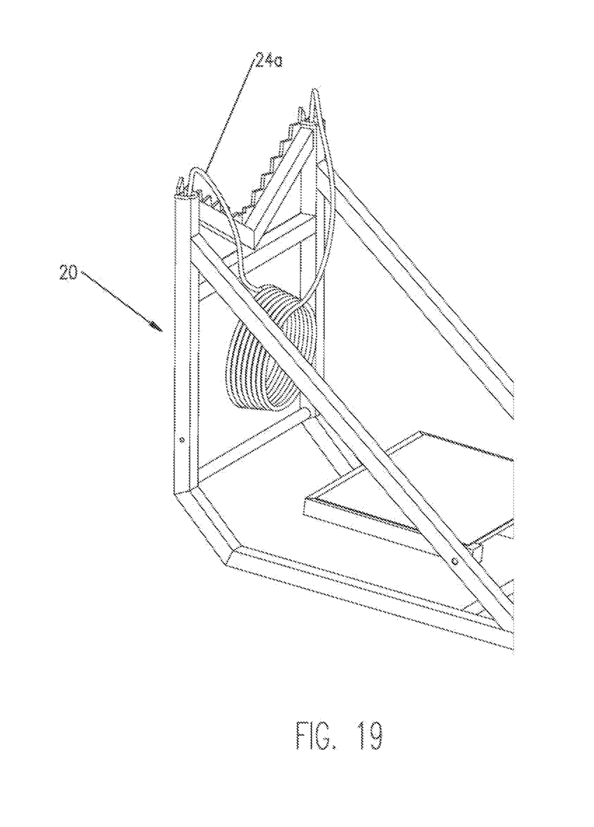

FIG. 17 shows an optional sheath through which the cabled may be routed. FIG. 18 shows the teeth on the tree anchor 22 in greater detail. In this embodiment the cables 24a-b are anchored to the outside the frame of the carriage 20. FIG. 19 shows an alternative embodiment in which the cables represented by the cable 24a are attached to an anchor on the inside of frame of the carriage 20. This anchoring configuration facilitates crossing the cables around the support tree.

The embodiment of the deer stand shown in FIGS. 1-19 includes a foldable ladder including multiple ladder sections connected to each other by hinges. This allows the ladder sections to be folded against each other into a packed configuration to facilitate human carrying the deer stand like a back pack. The hinges between the sections increase in height from the ladder progressively along the length of the ladder to allow the ladder sections to fold in the same direction (roll up), rather than folding in a “z” configuration, to facilitate folding the ladder while the ladder is laying on the ground. The hinges are configured to fold away from the tree as the ladder leans against the tree to prevent the ladder from folding under the weight of a person climbing the ladder. The tree braces located at the junctions between the ladder sections provide further support preventing the ladder from folding under the weight of a person climbing the ladder.

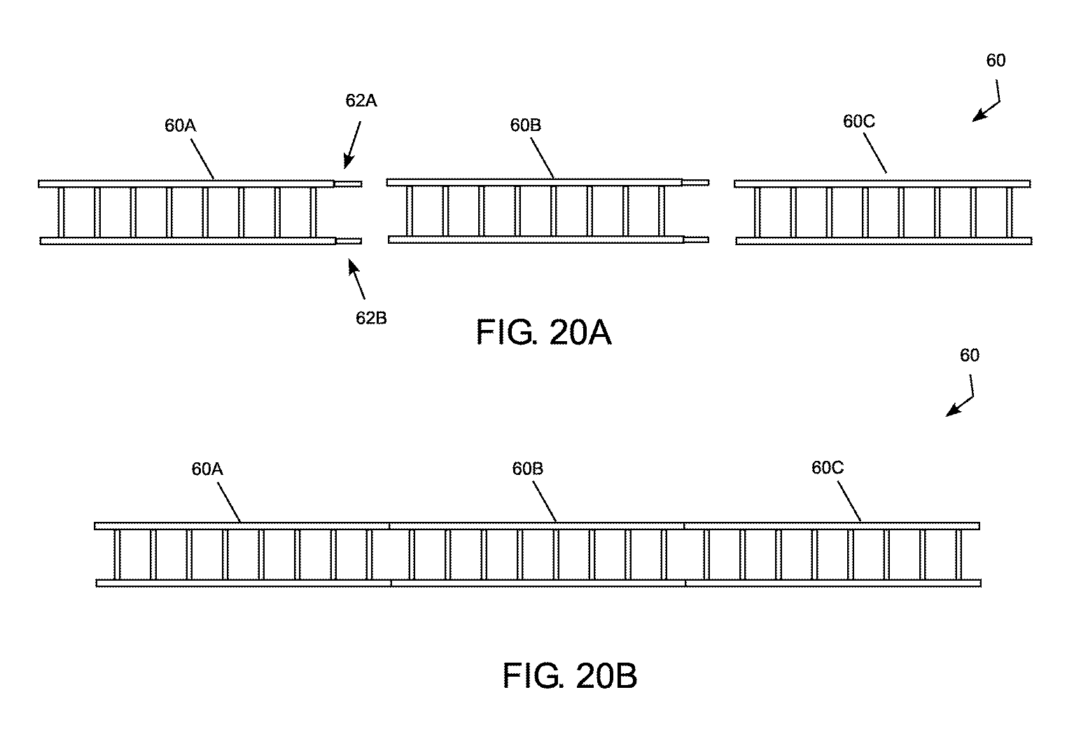

FIGS. 20A-B show a demountable alternative configuration for the ladder 60 consisting of separable ladder sections 62A-C connected by demountable coupler, such as the representative male-female couplers 62A-B. FIG. 20A shows the demountable ladder with the sections separated and FIG. 20B shows the demountable ladder with the sections connected to each other. The demountable ladder configuration allows the ladder to be broken down into separate ladder sections to facilitate human carrying of the ladder. This configuration may eliminate the need for one or both of the tree braces provided that that the separable couplers are sufficiently strong to support the weight of a person climbing the ladder.

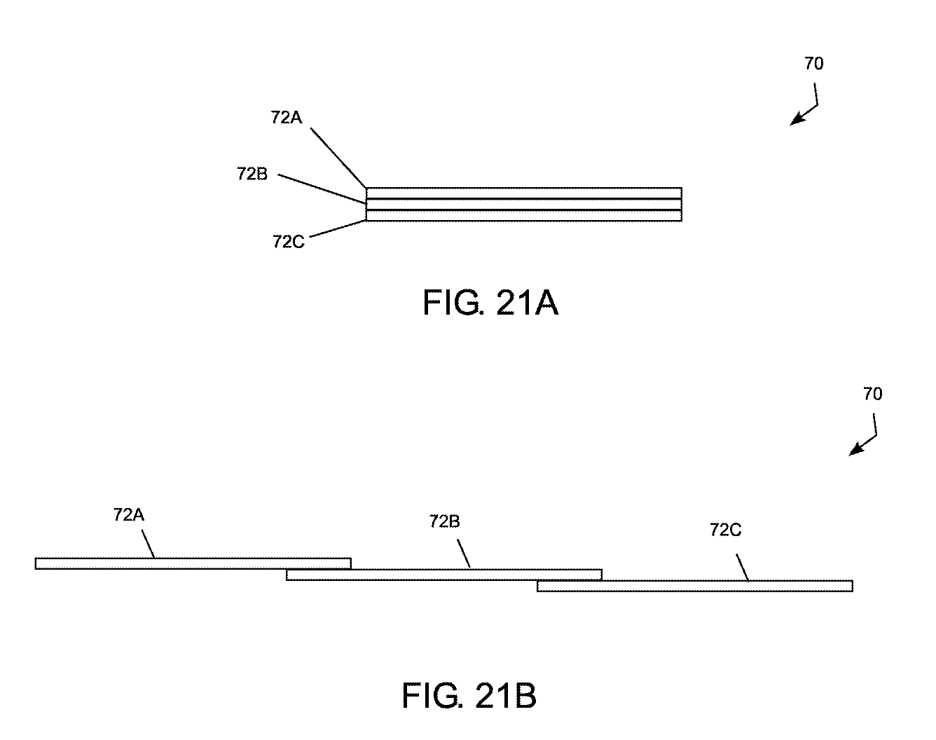

FIGS. 21A-B show a sliding alternative configuration 70 for the ladder consisting of slidable ladder sections 72A-C similar to a conventional extension ladder. FIG. 21A shows the extension ladder in the retracted configuration and FIG. 21B shows the extension ladder in the extended configuration. This configuration includes locking mechanism between the ladder sections, which may be similar to the locking mechanisms in a conventional extension ladder. The extension ladder configuration allows the ladder sections to slide against each other to extend and retract the ladder to facilitate human carrying of the ladder. This configuration may also eliminate the need for one or both of the tree braces provided that that the slidable couplers are sufficiently strong to support the weight of a person climbing the ladder.

The invention claimed is:

1. A deer stand configured to lean against and be secured to a tree, comprising:
a ladder;
a tree anchor connected at or near an upper end of the ladder configured to engage a tree while the ladder extend upwards from the ground and leans against the tree;
a cable anchor located at or near a lower end of the ladder;
at least one cable configured to extend from the tree anchor, around the tree, and coupled to the cable anchor;
a cable tensioning device for tightening the cable while the cable extends from the tree anchor, around the tree, and coupled to the cable anchor to secure the deer stand to the tree;
wherein the cable is connected or configured to be connected at or near an upper end of the ladder prior to leaning the ladder against the tree configured with the cable hanging downward to or near ground level when the ladder is leaned against the tree in an upright position; and
wherein the cable is further configured to be wrapped around the tree, coupled to the cable anchor, and tightened to secure the ladder to the tree by an operator standing on the ground without climbing the ladder prior to tightening the cable to secure the ladder to the tree.

2. The deer stand of claim 1, wherein the tree anchor further comprises teeth for digging into the tree when the ladder is tightened to the tree to aid is securing the ladder to the tree.

3. The deer stand of claim 1, wherein the cable tensioning device comprises a winch for gathering and tightening the cable.

4. The deer stand of claim 1, wherein the cable is a first cable, further comprising a second cable extendable from tree anchor for coupling with the cable anchor.

5. The deer stand of claim 3, further comprising a yoke coupling the cable tensioning device to the cables to equalize tension in the cables.

6. The deer stand of claim 1, further comprising a seat located at or near the upper end of the ladder.

7. The deer stand of claim 1, further comprising a foot rest located at or near the upper end of the ladder.

8. The deer stand of claim 1, further comprising a tree brace configured to extend from an intermediate location on the ladder to the tree when the deer stand is secured to the tree.

9. The deer stand of claim 1, further comprising two tree braces of unequal length, each configured to extend from a respective intermediate location on the ladder to the tree when the deer stand is secured to the tree.

10. The deer stand of claim 1, wherein:
the ladder comprises a plurality of sections connected to each other by hinges; and
the sections are configured to be folded against each other into a packed configuration to facilitate human carrying of the deer stand.

11. The deer stand of claim 1, wherein:
the ladder comprises a plurality of sections connected to each other by separable couplers; and
the sections are configured to be separated from each other facilitate human carrying of the deer stand.

12. The deer stand of claim 1, wherein:
the ladder comprises a plurality of sections connected to each other by slidable couplers; and
the sections are configured to slide with respect to each other into a retracted configuration to facilitate human carrying of the deer stand.

13. The deer stand of claim 1, wherein the cable is routed partially through a tubular section forming the tree anchor or near the tree anchor.

14. The deer stand of claim 1, wherein the cable is permanently attached to or near the tree anchor.

15. The deer stand of claim 1, wherein the cable is removably attachable to or near the tree anchor.

16. A deer stand configured to lean against and be secured to a tree, comprising:
a ladder;
a tree anchor connected at or near an upper end of the ladder configured to engage a tree while the ladder extend upwards from the ground and leans against the tree;
a cable anchor located at or near a lower end of the ladder;
at least one cable configured to extend from the tree anchor, around the tree, and coupled to the cable anchor;
a cable tensioning device for tightening the cable while the cable extends from the tree anchor, around the tree, and coupled to the cable anchor to secure the deer stand to the tree;
wherein the cable is connected or configured to be connected at or near an upper end of the ladder prior to leaning the ladder against the tree configured with the cable hanging downward to or near ground level when the ladder is leaned against the tree in an upright position;
wherein the cable is further configured to be wrapped around the tree, coupled to the cable anchor, and tightened to secure the ladder to the tree by an operator standing on the ground without climbing the ladder prior to tightening the cable to secure the ladder to the tree; and
wherein the ladder is foldable, demountable or sliding between a retracted configuration and an extended configuration to facilitate retracting the deer stand into a packed configuration that can be carried by a person like a backpack.

17. The deer stand of claim 16, wherein the cable tensioning device comprises a winch for gathering and tightening the cable.

18. The deer stand of claim 17, wherein the cable is a first cable, further comprising a second cable extendable from tree anchor for coupling with the cable anchor.

19. The deer stand of claim 18, further comprising a yoke coupling the cable tensioning device to the cables to equalize tension in the cables.

20. A deer stand configured to lean against and be secured to a tree, comprising:
a ladder;
a tree anchor connected at or near an upper end of the ladder configured to engage a tree while the ladder extend upwards from the ground and leans against the tree;
a cable anchor located at or near a lower end of the ladder;
at least one cable configured to extend from the tree anchor, around the tree, and coupled to the cable anchor;
a cable tensioning device for tightening the cable while the cable extends from the tree anchor, around the tree, and coupled to the cable anchor to secure the deer stand to the tree;
wherein the cable is connected or configured to be connected at or near an upper end of the ladder prior to leaning the ladder against the tree configured with the cable hanging downward to or near ground level when the ladder is leaned against the tree in an upright position;
wherein the cable is further configured to be wrapped around the tree, coupled to the cable anchor, and tightened to secure the ladder to the tree by an operator standing on the ground without climbing the ladder prior to tightening the cable to secure the ladder to the tree;
wherein the ladder is foldable between a retracted configuration and an extended configuration to facilitate retracting the deer stand into a packed configuration that can be carried by a person like a backpack, and
wherein the ladder sections are connected to each other by progressively sized hinges configured to allow the ladder section to be folded onto each other in the same direction from the ground while the ladder is laying on the ground.
